(19) United States
(12) Patent Application Publication
(10) Pub. No.: US 2020/0136521 A1
(43) Pub. Date: Apr. 30, 2020

(54) HIGH FREQUENCY TIME-DIVISION MULTI-PHASE POWER CONVERTER

(71) Applicant: JING-YUAN LIN, New Taipei City (TW)

(72) Inventors: JING-YUAN LIN, New Taipei City (TW); KUO-SYUN CHIEN, Chiayi County (TW); FU-CIAO SYU, New Taipei City (TW); ZHONG-HENG LI, Taichung City (TW)

(21) Appl. No.: 16/267,402

(22) Filed: Feb. 5, 2019

(30) Foreign Application Priority Data
Oct. 24, 2018 (TW) 107137551

(51) Int. Cl. H02M 3/335

(52) U.S. Cl. CPC H02M 3/33592; H02M 3/33561

(57) ABSTRACT

A high frequency time-division multi-phase power converter includes a power source, a switching circuit, a first resonant tank, a coreless transformer, a second resonant tank, an output rectifier circuit, an output load circuit and a control circuit. The switching circuit includes a first half bridge circuit and a second half bridge circuit connected in parallel. The first resonant tank includes a first resonant inductor, a first resonant capacitor and a first magnetizing inductor. The coreless transformer includes a primary side coil and a secondary side coil. The second resonant tank includes a second resonant capacitor and a second resonant inductor. The control circuit controls the switching circuit to be switched between multiple switching states, and ON states in a switching cycle of the first upper bridge switch, the first lower bridge switch, the second upper bridge switch, and the second lower bridge switch are mutually exclusive.

### CROSS-REFERENCE TO RELATED PATENT APPLICATION

This application claims the benefit of priority to Taiwan Patent Application No. 107137551, filed on Oct. 24, 2018. The entire content of the above identified application is incorporated herein by reference.

Some references, which may include patents, patent applications and various publications, may be cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD OF THE DISCLOSURE

The present invention relates to a power converter, and more particularly to a high frequency time-division multi-phase power converter.

### BACKGROUND OF THE DISCLOSURE

Low-power DC-DC power converters account for a large proportion of the market of power converters, and have been utilized by electronic devices in daily life, such as mobile phones, tablets, laptops, game consoles. Therefore, it is particularly important to improve the efficiency of the low-power DC-DC power converter.

In response to market demands and trends, the overall size of circuit converters becomes light and thin, with the goal of not occupying space and being convenient to carry. A switching power supply can be made lighter and thinner by increasing the switching frequency.

However, since the magnetic core of iron-material transformer commonly used in the existing switching power supply has the limitation in frequency, the increase of the frequency is limited. Furthermore, the existing silicon-based semiconductor components have bigger parasitic conductance in high frequency, resulting in more switching loss.

Therefore, it has become an important issue in the art to realize the converter suitable for high-frequency operation and reduce the switching loss and conduction loss in high-frequency operation of the circuit by improving the converter design.

### SUMMARY OF THE DISCLOSURE

The technical problem to be solved by the present invention is to provide a high frequency time-division multi-phase power converter, which can reduce the switching loss of the circuit operating in high frequency, and utilize synchronous rectification technology to reduce conduction loss.

The technical problem to be solved by the present disclosure is to provide a high frequency time-division multi-phase power converter, which includes a power source, a switching circuit, a first resonant tank, a coreless transformer, a second resonant tank, an output rectifier circuit, an output load circuit and a control circuit. The switching circuit is coupled to the power source, and the switching circuit includes a first half bridge circuit and a second half bridge circuit connected in parallel, the first half bridge circuit includes a first upper bridge switch and a first lower bridge switch, and the second half bridge switching circuit includes a second upper bridge switch and a second lower bridge switch. The first resonant tank is coupled to the first switch circuit and includes a first resonant inductor, a first resonant capacitor and a first magnetizing inductor. The coreless transformer is coupled to the first resonant tank and includes a primary side coil and a secondary side coil. The second resonant tank is coupled to the coreless transformer and includes a second resonant capacitor and a second resonant inductor. The output rectifier circuit is coupled to the second resonant tank and includes a plurality of rectifier components. The output load circuit includes an output capacitor and an output load. The control circuit is configured to control the switching circuit to be switched between multiple switching states, and ON states in a switching cycle of the first upper bridge switch, the first lower bridge switch, the second upper bridge switch, and the second lower bridge switch are mutually exclusive.

The technical problem to be solved by the present disclosure is to provide a high frequency time-division multi-phase power converter, which includes a power source, a switching circuit, a converter circuit, an output load circuit and a control circuit. The switching circuit is coupled to the power source and includes a plurality of first switches connected in parallel with respect to a first common end and a second common end. The converter circuit is coupled to the switch circuit and includes a diode and an inductor. The output load circuit includes an output capacitor and an output load. The control circuits is configured to control the switching circuit to be switched between multiple switching states, and ON states in a switching cycle of the plurality of first switches are mutually exclusive.

One of the beneficial effects of the present invention is that the high frequency time-division multi-phase power converter provided by the present disclosure uses a coreless flat-panel transformer as a main transmission power structure for being thinner and lighter. In addition, the primary side switches are provided with zero voltage switching function, and the synchronous rectification technique is utilized on the secondary side, so as to reduce the switching loss and conduction loss of the circuit operating in high frequency.

Another advantageous effect of the present disclosure is that the high frequency time-division multi-phase power converter provided by the present disclosure replaces the existing silicon-based power switches with gallium nitride power components in the primary and secondary side switches, thereby reducing the power converter volume and high-frequency switching loss, improving the power density of the overall circuit, reducing coil loss by the improvement of coil order design, and improving transformer coupling coefficient to improve transmission efficiency.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The present disclosure will become more fully understood from the following detailed description and accompanying drawings.

FIG. 1 is a circuit layout of a high frequency time-division multi-phase power converter according to an embodiment of the present disclosure.

FIG. 2 is a circuit layout of a high frequency time-division multi-phase power converter according to an embodiment of the present disclosure.

FIG. 3 is a diagram showing driving signals of a high frequency time-division multi-phase power converter according to an embodiment of the present disclosure.

FIG. 4 is a timing diagram showing synchronous rectification control signals of a high frequency time-division multi-phase power converter according to yet another embodiment of the present disclosure.

FIG. 5 is a schematic diagram of four layers of a coreless transformer according to an embodiment of the present disclosure.

FIG. 6 is a circuit layout of a high frequency time-division multi-phase power converter according to a second embodiment of the present disclosure.

FIG. 7 is a circuit operation timing diagram of a high frequency time-division multi-phase power converter according to the second embodiment of the present disclosure.

FIG. 8 is a circuit layout of a high frequency time-division multi-phase power converter according to a third embodiment of the present disclosure.

FIG. 9 is a circuit operation timing diagram of a high frequency time-division multi-phase power converter according to the third embodiment of the present disclosure.

FIG. 10 is a circuit layout of a high frequency time-division multi-phase power converter according to a fourth embodiment of the present disclosure.

FIG. 11 is a circuit operation timing diagram of a high frequency time-division multi-phase power converter according to the fourth embodiment of the present disclosure.

FIG. 12 is a circuit layout of a high frequency time-division multi-phase power converter according to a fifth embodiment of the present disclosure.

FIG. 13 is a circuit operation timing diagram of a high frequency time-division multi-phase power converter according to the fifth embodiment of the present disclosure.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a”, “an”, and “the” includes plural reference, and the meaning of “in” includes “in” and “on”. Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first”, “second” or “third” can be used to describe various components, signals or the like, which are for distinguishing one component/signal from another one only, and are not intended to, nor should be construed to impose any substantive limitations on the components, signals or the like.

The he “high frequency time-division multi-phase power converter” disclosed in the present disclosure are described below by way of specific embodiments, and those skilled in the art can understand the advantages and effects of the present disclosure from the disclosure of the present specification. The present disclosure can be implemented or applied in various other specific embodiments, and various modifications and changes can be made without departing from the spirit and scope of the present disclosure. In addition, the drawings of the present invention are merely illustrative and are not intended to be stated in the actual size. The following embodiments will further explain the related technical content of the present disclosure, but the disclosure is not intended to limit the scope of the present disclosure.

It should be understood that, although the terms “first”, “second”, “third”, and the like may be used herein to describe various elements or signals, however, these elements or signals are not limited by these terms. These terms are primarily used to distinguish one element from another or one signal from another. In addition, the term “or” as used herein may include a combination of any one or more of the associated listed items, depending on the actual situation.

### First Embodiment

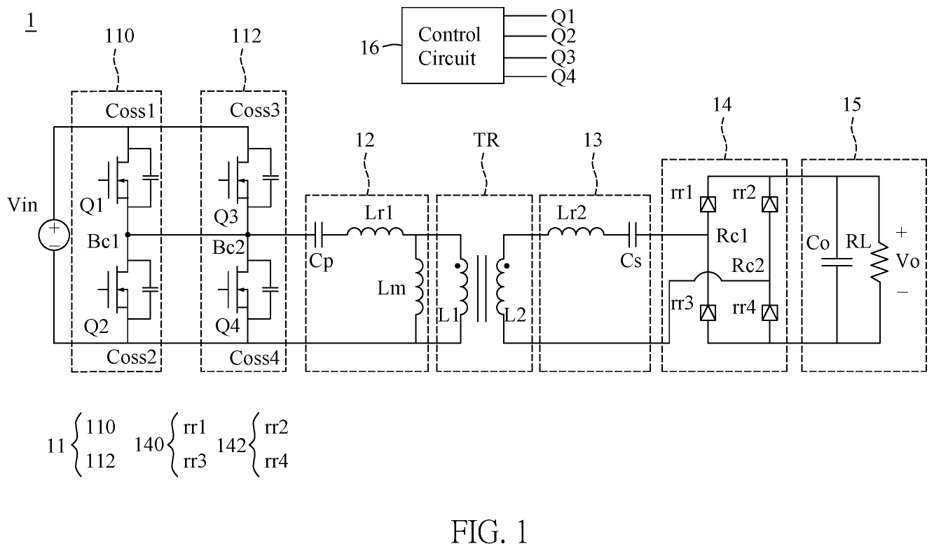

Referring to FIG. 1, a first embodiment of the present disclosure provides a high frequency time-sharing multiphase power converter 1, which includes a power source Vin, a switching circuit 11, a first resonant tank 12, coreless transformer TR, a second resonant tank 13, an output rectifier circuit 14, an output load circuit 15 and a control circuit 16.

The switching circuit 11 is coupled to the power source Vin and includes a first half bridge circuit 110 and a second half bridge circuit 112 connected in parallel. The first resonant tank 12 is coupled to the switching circuit 11 and includes a first resonant capacitor Cp, a first resonant inductor Lr, and a magnetizing inductor Lm. The coreless transformer TR is coupled to the first resonant tank 12 and includes a primary side coil L1 and a secondary side coil L2.

The second resonant tank 13 is coupled to the coreless transformer TR and includes a second resonant capacitor Cs and a second resonant inductor Lr2. The output rectifier circuit 14 is coupled to the second resonant tank 13 and includes a plurality of rectifier components rr1, rr2, rr3, and rr4.

The output load circuit 15 includes an output capacitor Co and an output load RL. The control circuit 15 is configured to control the switching circuit 11 to be switched between multiple switching states. Here, ON states in a switching cycle of a first upper bridge switch Q1, a first lower bridge switch Q2, a second upper bridge switch Q3, and a second lower bridge switch Q4 are mutually exclusive. In this case, a first upper and lower bridge center point Bc1 between the first upper bridge switch Q1 and the first lower bridge switch Q2 is connected to a second upper and lower bridge center point Bc2 between the second upper bridge switch Q3 and the second lower bridge switch Q4.

Since the coreless transformer TR is similar to the existing transformer, energy is transformed by coupling magnetic field lines between the primary and secondary side coils. In general, a coupling coefficient of the existing transformer is usually greater than 0.9, while the coupling coefficient of the coreless transformer TR is much smaller than that of the existing transformer. If the coupling coefficient is less than 0.5, the ratio of leakage inductance at the primary and secondary sides will be greater than the inductance of the magnetizing inductor Lm, and the effective transmission power cannot be achieved. In order to solve the problem, the first resonant capacitor Cr1 is added to a resonant tank on the primary side by the compensation of the bilateral resonant technique to generate a sinusoidal power source that complies with the secondary side resonant frequency, and a resonance technique is also incorporated in the secondary side to improve the efficiency of power transmission.

In the present disclosure, half-bridge resonant converter architecture is utilized on the primary side. Since the parallel resonant type and the series-parallel resonant converters generally have a large circulating current flow, a large loss is easily caused in the resonant inductor. In the circuit of wireless energy transmission, a series-series converter advantages over a series-parallel converter in efficiency. Therefore, the present disclosure utilizes the series-series technique. The architecture applied to the series-series resonant circuit is similar to a series resonant converter (SRC) or an LLC resonant converter.

Here, the first upper bridge switch Q1, the first lower bridge switch Q2, the second upper bridge switch Q3, and the second lower bridge switch Q4 can be gallium nitride switches. It should be noted that the present disclosure takes gallium nitride power components as the switching components of the resonant circuit. In order to improve the circuit efficiency and reduce the switching loss, the circuit will be designed to be operated in an inductive interval, so as to achieve zero voltage switching.

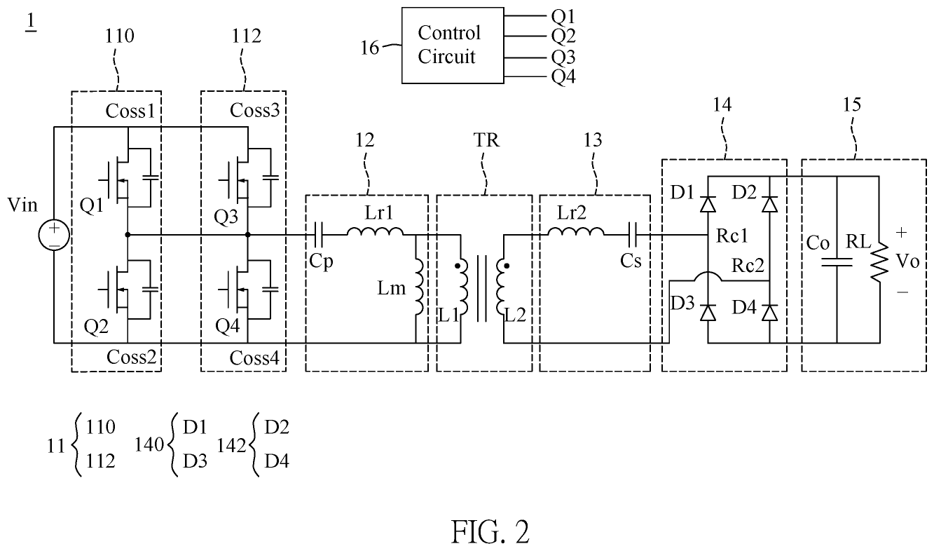

The time-division multi-phase power converter 1 can be shown in FIG. 2, which is a circuit layout of a high frequency time-division multi-phase power converter according to another embodiment of the present disclosure. Here, the first half bridge circuit 100 includes the first upper bridge switch Q1 and the first lower bridge switch Q2, and the second half bridge switching circuit includes the second upper bridge switch Q3 and the second lower bridge switch Q4. Capacitors Coss1, Coss2, Coss3, and Coss4 are switching output capacitors of the first upper bridge switch Q1, the first lower bridge switch Q2, the second upper bridge switch Q3, and the second lower bridge switch Q4, respectively. In the present embodiment, the output rectifier circuit 14 includes a first rectifier circuit 140 and a second rectifier circuit 142 connected in parallel, the first rectifier circuit 140 includes the rectifier component rr1 and the rectifier component rr3, the second rectifier circuit 142 includes the rectifier component rr2 and the rectifier component rr4, and a first rectifier circuit center point Rc1 between the rectifier component rr1 and the rectifier component rr3 is coupled to a first end of the second resonant tank 13, and a second rectifier circuit center point Rc2 between the rectifier component rr2 and the rectifier component rr4 is coupled to a second end of the second resonant tank 13. In the present embodiment, the rectifier components rr1, rr2, rr3, and rr4 can be rectifier diodes D1, D2, D3, and D4.

In detail, the architecture utilized by the present disclosure and the half-bridge resonant converter both utilize the resonance technique, such that the first upper bridge switch Q1, the first lower bridge switch Q2, the second upper bridge switch Q3, and the second lower bridge switch Q4 can achieve zero voltage switching while being turned on. In order to enable the first resonant tank 12 to reach a higher frequency, the first upper bridge switch Q1, the first lower bridge switch Q2, the second upper bridge switch Q3, and the second lower bridge switch Q4 are sequentially turned on. By using the phase shifting method, each switching signal has a difference of 90 degrees, and no more than two switches will be turned on at the same time. That is, ON states of the first upper bridge switch Q1, the first lower bridge switch Q2, the second upper bridge switch Q3, and the second lower bridge switch Q4 are mutually exclusive. Since this control method is used, different from the duty cycle for the existing half-bridge series resonant converter being 50%, the duty cycle for the present embodiment should be reduced to less than 25% to avoid two of the first upper bridge switch Q1, the first lower bridge switch Q2, the second upper bridge switches Q3, and the second lower bridge switch Q4 being simultaneously turned on.

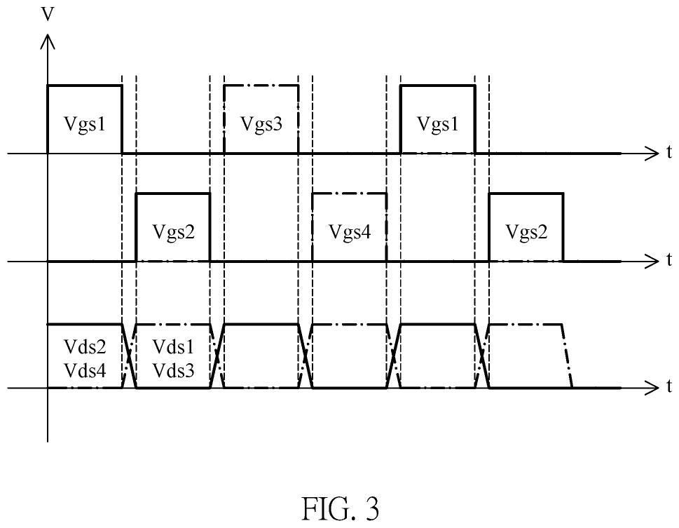

Reference is now made to FIG. 3, which is a diagram showing driving signals of a high frequency time-division multi-phase power converter according to an embodiment of the present disclosure. As the first switching signal Vgs1, the second switching signal Vgs2, the third switching signal Vgs3, and the fourth switching signal Vgs4 of the first upper bridge switch Q1, the first lower bridge switch Q2, the second upper bridge switch Q3, and the second lower bridge switch Q4 shown in FIG. 3, when the first upper bridge switch Q1 and the first lower bridge switch Q2 are sequentially turned on or off, the operating frequency of the first resonant tank 12 can be regarded as twice the first switching signal Vgs1 and the second switching signal Vgs2.

In addition, as the first on-voltage Vds1, second on-voltage Vds2, the third on-voltage Vds3, and the fourth on-voltage Vds4 of the first upper bridge switch Q1, the first lower bridge switch Q2, the second upper bridge switch Q3, and the second lower bridge switch Q4 shown in the simple timing diagram shown in FIG. 3, since the capacitor Coss3 of the second upper bridge switch Q3 is connected in parallel with the capacitor Coss1, a voltage waveform on the capacitor Coss1 is the same as a voltage waveform on the capacitor Coss3.

Similarly, a voltage waveform of the capacitor Coss2 of the first lower bridge switch Q2 is the same as a voltage waveform of the capacitor Coss4 of the second lower bridge switch Q4. After the switching signals of the first upper bridge switch Q1 and the first lower bridge switch Q2 end, the second upper bridge switch Q3 and the second lower bridge switch Q4 continue to operate. Therefore, it can be observed that the capacitor Coss1, Coss3, Coss2, and Coss4 have the same voltage waveforms when the first upper bridge switch Q1 and the first lower bridge switch Q2 operate. It can be seen as a cycle from starting points of the switching signals of the first upper bridge switch Q1, the first lower bridge switch Q2, the second upper bridge switch Q3, and the second lower bridge switch Q4 to the end points thereof and the voltages on the first resonant tank 12, the first upper bridge switch Q1, the first lower bridge switch Q2, the second upper bridge switch Q3, and the second lower bridge switch Q4 have been repeated in the same operation interval, and the operating frequency of the first resonant tank 12 can be regarded as twice of the first switching signal Vgs1, the second switching signal Vgs2, the third switching signal Vgs3 and the fourth switching signal Vgs4. Based on the above, it can be seen that the time division multi-phase architecture utilizes two or more half-bridge circuits to drive a resonant tank in a signal phase-interleaving manner, such that a frequency can be doubled or even three times for the first resonant tank 12.

When the high frequency time-division multi-phase power converter 1 of the embodiment of the present disclosure operates at a fixed gain point, the characteristic thereof is indicated to be operated in the inductive interval. When operating in this inductive interval, the circuit action is similar to that of the half-bridge series resonant converter (SRC), and the output voltage will not change too much, and the zero voltage switching is achieved as the load current increases. When the time division multi-phase power converter 1 operates in this interval, the function of the zero-voltage switching on the primary side can be achieved.

Therefore, in the high frequency time-division multi-phase power converter of the present disclosure, the main power architecture is achieved by two half-bridge converter switches connected in parallel, and the resonant tank can be operated by a signal with multiple signal frequency of the primary side switching signal through the switching control, and the primary side switch has the zero voltage switching function to reduce the switching loss of the circuit operating in high frequency. Therefore, the overall circuit can operate at a higher switching frequency, and the virtual power of the circuit can be compensated and the overall transmission efficiency can be increased through the bilateral resonance technology.

In the embodiment of FIG. 2, the rectifier diodes D1, D2, D3, and D4 may employ Schottky Diodes as the secondary side rectifier diodes. However, when the diode acts as a rectifier, the conduction loss increases with the output current due to the generated voltage drop. In another embodiment, in order to reduce the conduction loss, solve the problem of component heat and improve the efficiency of the converter, the Schottky diodes are replaced with gallium nitride switch transistors having a small on-resistance. For example, the rectifier component rr1, the rectifier component rr2, the rectifier component rr3, and the rectifier component rr4 may be used as rectifying switches for synchronous rectification to reduce conduction loss.

In the operating frequency range of the high frequency time-division multi-phase power converter of the present disclosure, the primary side of the transformer TR has current flowing at all times, and is in a state of transmitting energy throughout the duty cycle, which is similar to the operating principle of the half-bridge resonant converter circuit SRC (Region1). Therefore, different from the LLC-SRC (Region2), the addition of synchronous rectification will not cause the output current to be reversely injected.

The operation principle of the LLC-SRC is quite different from the present disclosure, so the detail of synchronous rectification signal will not be described herein. The rectification switch using synchronous rectification is different from the rectifying diodes D1, D2, D3 and D4 in that when the synchronous rectifier switches are turned off, there is still current flowing in the primary side of the transformer TR, so the current flowing out from the secondary side is kept by the source and the drain of the synchronous rectifier switch. Therefore, it should be noted that the source and the drain of the synchronous rectifier switch should be placed in the same position as the original rectifier diodes D1, D2, D3 and D4.

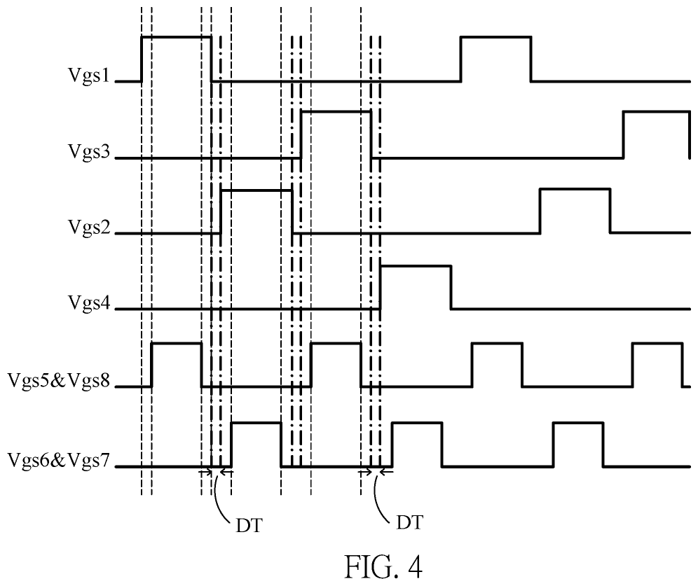

Reference is now made to FIG. 4, which is a timing diagram showing synchronous rectification control signals of a high frequency time-division multi-phase power converter according to yet another embodiment of the present disclosure. As shown in FIG. 4, a synchronous rectification signal having the inductive range for operating the circuit is shown. Here, the control circuit 16 further controls the rectifier components rr1 and rr4 to be turned on in synchronization with the first upper bridge switch Q1 and the second upper bridge switch Q3, and controls the rectifier components rr2 and rr3 to be turned on in synchronization with the first lower bridge switch Q2 and the second lower bridge switch Q4.

In more detail, the control signals Vgs5 and Vgs8 of the synchronous rectifier components rr1 and rr4 should be delayed to be turned on and to be turned off beforehand with respect to the first switching signal Vgs1 and the third switching signal Vgs3 of the corresponding first upper bridge switch Q1 and second upper bridge switch Q3. Similarly, the control signals Vgs6 and Vgs7 of the synchronous rectifier components rr2 and rr3 must be delayed to be turned on and to be turned off beforehand with respect to the second switching signal Vgs2 and the fourth switching signal Vgs4 of the corresponding first lower bridge switch Q1 and second lower bridge switch Q3.

Similarly, a section in which all of the first upper bridge switch Q1, the first lower bridge switch Q2, the second upper bridge switch Q3, and the second lower bridge switch Q4 are turned off is referred to as a dead time DT. The dead time DT is used to prevent the short-circuited condition of the input voltage Vin caused when the first lower bridge switch Q2 is turned on and the first upper bridge switch Q1 is not completely turned off.

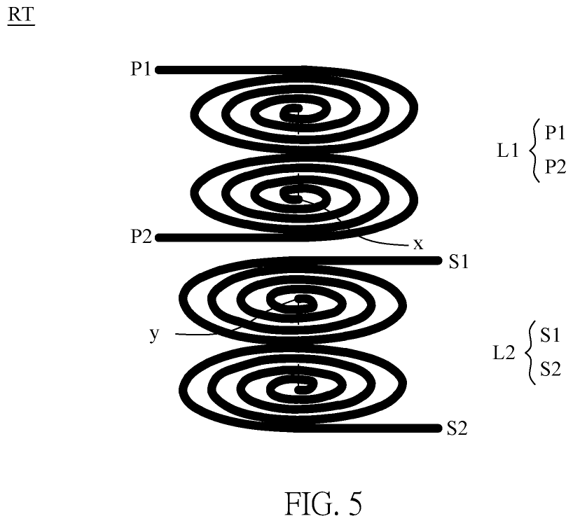

Furthermore, reference is now made to FIG. 5, which is a schematic diagram of four layers of a coreless transformer according to an embodiment of the present disclosure. As shown in FIG. 5, a coreless flat panel transformer RT is also used in the embodiment of the present disclosure, which is composed of two spiral coils. In order to increase the inductance value under a limited area, the coils are connected in series. Here, the primary side coil L1 includes a first primary side winding P1 and a second primary side winding P2, and the secondary side coil L2 includes a first secondary side winding S1 and a second secondary side winding S2, the first primary side winding P1 and the second primary side winding P2 are connected in series by a series connection point x through a via, and the first secondary side winding S1 and the second secondary side winding S2 are connected in series by a series connection point y through another via.

Further, in order to increase the coupling coefficient, the air gap between the two coils is reduced by placing the primary side and secondary side coils in a four-layer board of the same printed circuit board. By concentrating the primary and secondary sides into the same circuit board in the manner described above, the overall volume of the transformer can be reduced, and the coupling coefficient and the power transfer efficiency can be increased. Furthermore, the arrangement of the primary side and secondary side coil winding sequences has an influence on the internal magnetomotive force distribution, the coupling coefficient, and the coil loss of the transformer. Preferably, the staggered winding of the PSSP can be used, which has the highest coupling coefficient and has the smallest loss.

Therefore, it can be seen that the high frequency time-division multi-phase architecture of the present disclosure can be applied to a resonant converter and a pulse width modulation converter. When the frequency is high enough, a coreless transformer design can reduce the core loss generated in the existing transformer.

### Second Embodiment

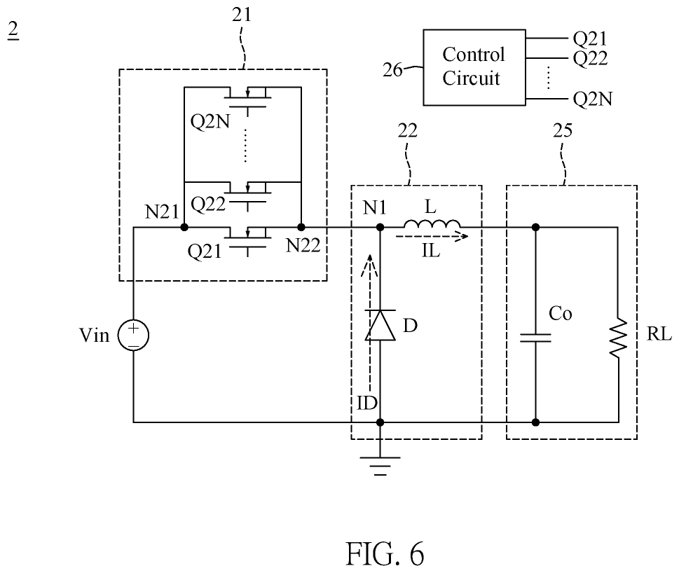

Reference is now made to FIG. 6, which is a circuit layout of a high frequency time-division multi-phase power converter according to a second embodiment of the present disclosure. The second embodiment of the present disclosure provides a high frequency time-division multi-phase power converter 2, which includes the power source Vin, the switching circuit 21, the converter circuit 22, the output load circuit 25 and the control circuit 26.

The switching circuit 21 is coupled to the power source Vin and includes a plurality of first switches Q21, Q22, . . . , Q2N connected in parallel with respect to a first common end N21 and a second common end N22. The converter circuit 22 is coupled to the switch circuit 21 and includes a diode D and an inductor L, and the output load circuit 25 is coupled to the converter circuit 22 and includes an output capacitor Co and an output load RL.

In the present embodiment, the high frequency time-division multi-phase power converter 2 is a non-isolated buck DC converter. As shown in FIG. 6, one end of the inductor L is coupled to one end of the diode D, the other end of the inductor L is coupled to the output capacitor Co and the output load RL, the first common end N21 of the switching circuit 21 is coupled to the power source Vin and a first node Ni between the inductor L and the diode D, and the second common end N22 is coupled to a ground end.

Similar to the previous embodiment, the control circuit 26 can be configured to control the switching circuit 21 to be switched between multiple switching states. Here, ON states in a switching cycle of the first switches Q21, Q22, . . . , Q2N are mutually exclusive.

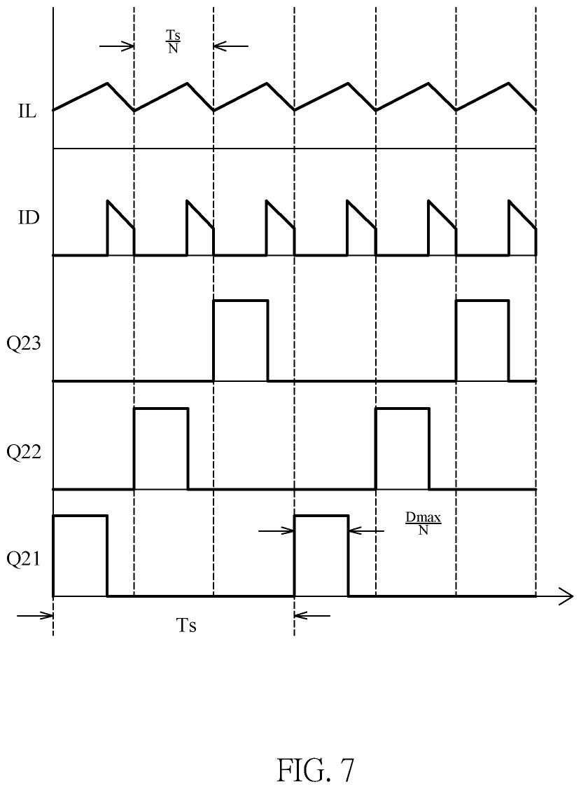

In detail, reference is now made to FIG. 7, which is a circuit operation timing diagram of a high frequency time-division multi-phase power converter according to the second embodiment of the present disclosure. When N is 3, the switches Q21, Q22, and Q23 may be power switches, and the respective ON states of the switches Q21, Q22, and Q23 in the switching cycle Ts are mutually exclusive. When one of the switches Q21, Q22, Q23 is turned on, the power source Vin will be supplied to the output load RL. At this time, an inductor current IL will flow through the inductor L in a forward direction. Since one of the switches Q21, Q22, and Q23 is in saturation, the potential of the cathode of the diode D is approximately equal to the input voltage of the power source Vin. Therefore, the diode D is now reverse biased, and the output capacitor Co will be charged. On the other hand, when the switches Q21, Q22, and Q23 are turned off, the polarity of the voltage on the inductor L is reversed, so that the diode D is in the forward bias state and has the diode current ID. The energy stored in the output capacitor Co can be discharged to the output load RL via the diode D and the inductor L. In this embodiment, since the operation period of the inductor L and the diode D is the switching cycle Ts divided by the number of switches Q21 to Q2N, that is, N, the frequency is also N times of the switches Q21 to Q2N, thereby reducing areas of the inductor L and the diode D.

In addition, the on-time of the switches Q21 to Q2N can be controlled by the control circuit 26 with pulse width modulation and can be obtained by dividing the maximum duty cycle Dmax with the number of switches Q21 to Q2N.

### Third Embodiment

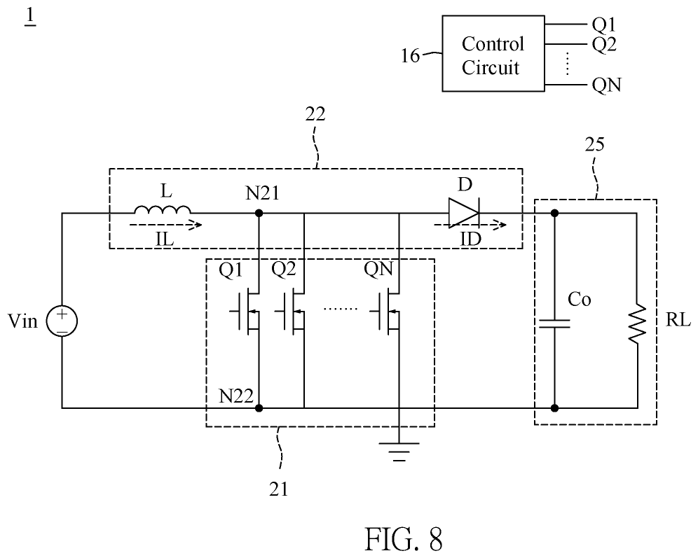

Reference is now made to FIG. 8, which is a circuit layout of a high frequency time-division multi-phase power converter according to a third embodiment of the present disclosure. The third embodiment of the present disclosure provides the high frequency time-division multi-phase power converter 2, which includes the power source Vin, the switching circuit 21, the converter circuit 22, the output load circuit 25 and the control circuit 26.

The switching circuit 21 is coupled to the power source Vin and includes a plurality of first switches Q21, Q22, . . . , Q2N connected in parallel with respect to a first common end N21 and a second common end N22. The converter circuit 22 is coupled to the switch circuit 21 and includes the diode D and an inductor L, and the output load circuit 25 is coupled to the converter circuit 22 and includes an output capacitor Co and an output load RL.

In the present embodiment, the high frequency time-division multi-phase power converter 2 is a non-isolated boost DC converter. As shown in FIG. 8, one end of the inductor L is coupled to the power source Vin, and the other end of the inductor L is coupled to one end of the diode D2, the other end of the diode D2 is coupled to the output capacitor Co and the output load RL, and the first common terminal N21 of the switch circuit 21 is coupled between the inductor L and the diode D2, and the second common terminal N22 is grounded.

Similar to the previous embodiment, the control circuit 26 can be configured to control the switching circuit 21 to be switched between multiple switching states. Here, ON states in a switching cycle of the first switches Q21, Q22, . . . , Q2N are mutually exclusive.

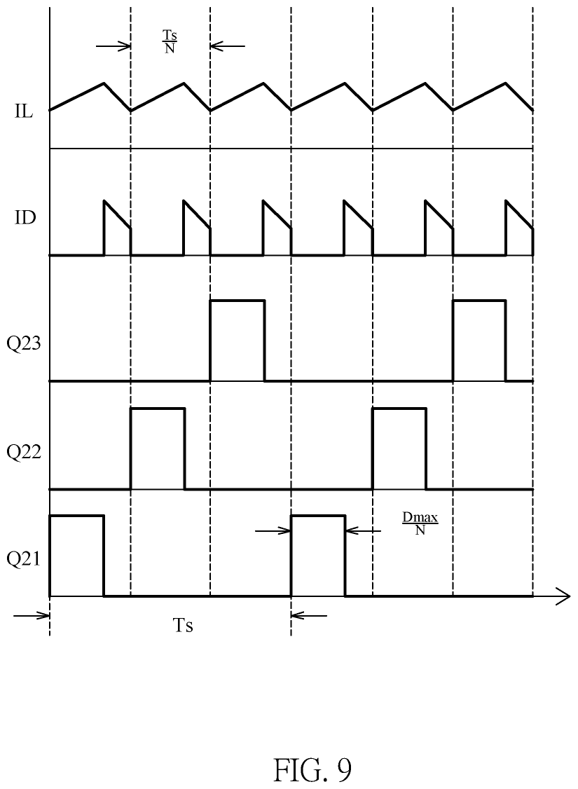

In detail, reference is now made to FIG. 9, which is a circuit operation timing diagram of a high frequency time-division multi-phase power converter according to the third embodiment of the present disclosure. When N is 3, the switches Q21, Q22, and Q23 may be power switches, and the respective ON states of the switches Q21, Q22, and Q23 in the switching cycle Ts are mutually exclusive. When one of the switches Q21, Q22, Q23 is turned on, the energy obtained by the power source Vin will be stored in the inductor L, and the potential of the anode of the diode D will be smaller than the input voltage of the power source Vin. Therefore, the diode D is now in the reverse bias state, and the output current is supplied from the output capacitor Co to the output load RL. On the other hand, when the switches Q21, Q22, and Q23 are turned off, an inductor current IL of the inductor L will continue to flow. The inductor L changes the magnetic field to change the polarity of the voltage, so that the diode D is in the forward bias state and has a diode current ID. In the meanwhile, the energy stored in the inductor L generates an output current and is discharged via the diode D to the output load RL. In this embodiment, since the operation period of the inductor L and the diode D is the switching cycle Ts divided by the number of switches Q21 to Q2N, that is, N, the frequency is also N times of the switches Q21 to Q2N, thereby reducing areas of the inductor L and the diode D.

Similarly, the on-time of the switches Q21 to Q2N can be controlled by the control circuit 26 with pulse width modulation and can be obtained by dividing the maximum duty cycle Dmax with the number of switches Q21 to Q2N.

### Fourth Embodiment

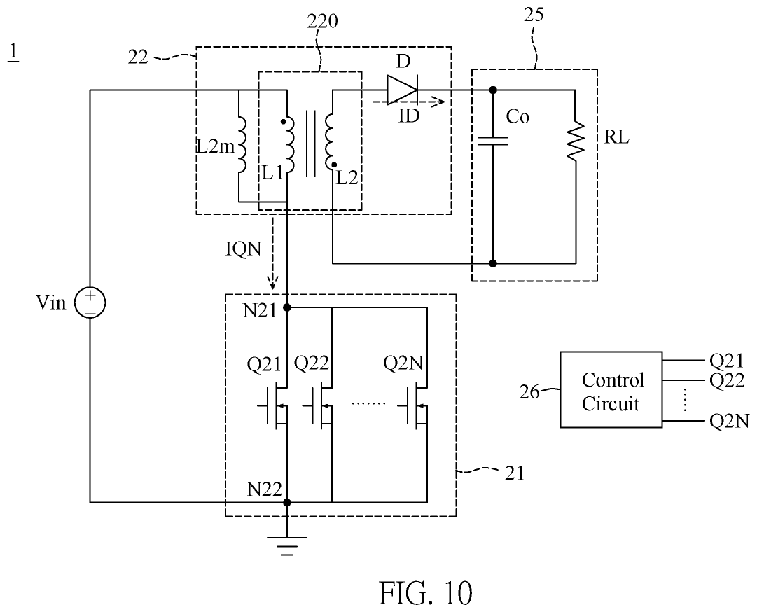

Reference is now made to FIG. 10, which is a circuit layout of a high frequency time-division multi-phase power converter according to a fourth embodiment of the present disclosure. The fourth embodiment of the present disclosure provides the high frequency time-division multi-phase power converter 2, which includes a power source Vin, a switching circuit 21, a converter circuit 22, an output load circuit 25 and a control circuit 26.

The switching circuit 21 is coupled to the power source Vin and includes a plurality of first switches Q21, Q22, . . . , Q2N connected in parallel with respect to a first common end N21 and a second common end N22. The converter circuit 22 is coupled to the switch circuit 21 and includes a diode D and an inductor L2m, and the output load circuit 25 is coupled to the converter circuit 22 and includes an output capacitor Co and an output load RL.

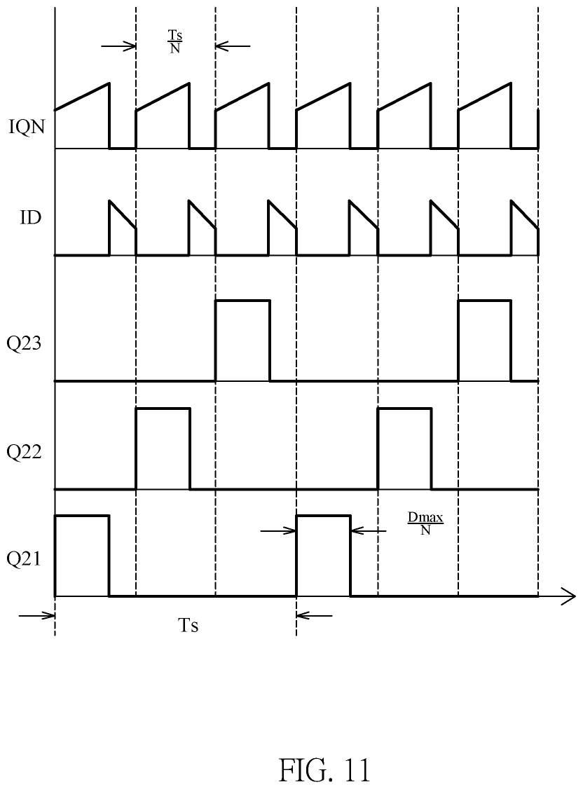

In the present embodiment, the high frequency time-division multi-phase power converter 2 is a non-isolated fly back DC converter. As shown in FIG. 11, the converter circuit 22 further includes a coreless transformer 220 including a primary side coil L1 and a secondary side coil L2. One end of the inductor L2m is coupled to the power source Vin and one end of the primary side coil L1, and the other end of the inductor L2m is coupled to the other end of the primary side coil L1 and the first common end N21 of the switch circuit 21, and the second common point N22 is coupled to a ground end. On the other hand, one end of the diode D2 is coupled to one end of the secondary side coil L2, and the other end of the diode D is coupled to the output capacitor Co and the output load RL.

Similar to the previous embodiment, the control circuit 26 can be configured to control the switching circuit 21 to be switched between multiple switching states, here, ON states in a switching cycle of the first switches Q21, Q22, . . . , Q2N are mutually exclusive.

In detail, reference is now made to FIG. 11, which is a circuit operation timing diagram of a high frequency time-division multi-phase power converter according to the fourth embodiment of the present disclosure. 2 When N is 3, the switches Q21, Q22, and Q23 may be power switches, and the respective ON states of the switches Q21, Q22, and Q23 in the switching cycle Ts are mutually exclusive. When one of the switches Q21, Q22, Q23 is turned on, the primary side coil L1 of the coreless transformer 220 gradually has a current flowing therethrough, and energy is stored therein. However, since the polarities of the primary side coil L1 and the secondary side coil L2 of the coreless transformer 220 are opposite, the diode D is in the reverse bias state, as a diode current ID of FIG. 11. Here, the energy is not transferred to the output load RL, and the output capacitance Co is used to provide the output energy.

During ON states of the switches Q21, Q22, and Q23, the energy is stored in the coreless transformer 220. At this time, only the primary side coil L1 is in an active state, so that the coreless transformer 220 can be regarded as a series inductor. In addition, the current of the primary side coil L1 linearly increases during ON states, which can be known from a current IQN of FIG. 11.

When the switches Q21, Q22, and Q23 are turned off, the current of the primary side coil L1 drops to zero. When the magnetic flux density changes to the negative direction, the polarities of the primary side coil L1 and the secondary side coil L2 will be reversed. Therefore, the diode D changes to a forward biased state and is turned on, and the magnetizing current is transferred to the secondary side coil L2. In other words, the energy of the coreless transformer 220 is transmitted to the output capacitor Co and the output load RL via the diode D.

Similarly, since the operation period of the inductor L and the diode D is the switching cycle Ts divided by the number of switches Q21 to Q2N, that is, N, the frequency is also N times of the switches Q21 to Q2N, thereby reducing areas of the inductor L and the diode D.

Similarly, the on-time of the switches Q21 to Q2N can be controlled by the control circuit 26 with pulse width modulation and can be obtained by dividing the maximum duty cycle Dmax with the number of switches Q21 to Q2N.

### Fifth Embodiment

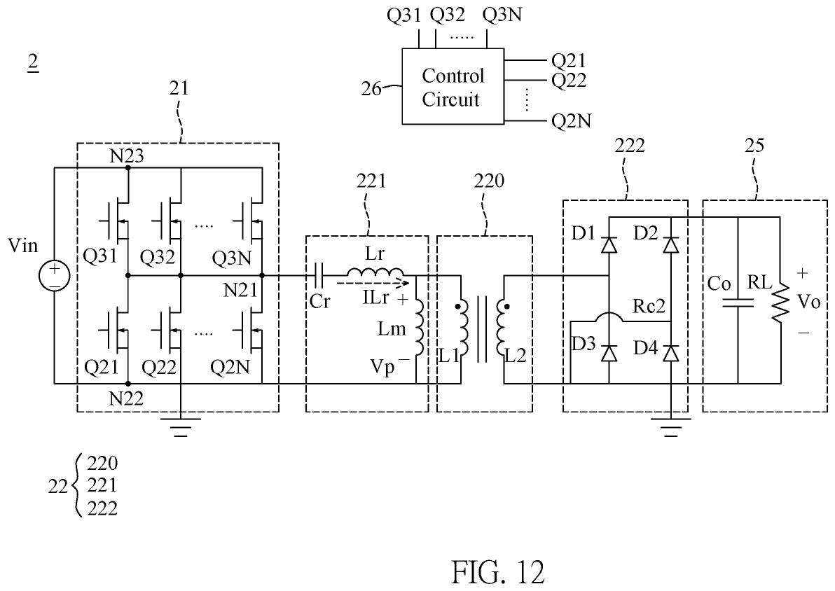

Reference is now made to FIG. 12, which is a circuit layout of a high frequency time-division multi-phase power converter according to a fifth embodiment of the present disclosure. The fifth embodiment of the present disclosure provides a high frequency time-division multi-phase power converter 2, which includes the power source Vin, a switching circuit 21, a converter circuit 22, an output load circuit 25 and a control circuit 26.

The switching circuit 21 is coupled to the power source Vin and includes a plurality of first switches Q21, Q22, . . . , Q2N connected in parallel with respect to a first common end N21 and a second common end N22. The switching circuit 21 further includes a plurality of second switches Q31, Q32, . . . , Q3N connected in parallel with respect to the first common end N21 and a third common end N23, and the third common end N23 is coupled to the power source Vin, and the second common end N22 is coupled to a ground end.

The converter circuit 22 is coupled to the switch circuit 21 and includes the diode D and an inductor L2m, and the output load circuit 25 is coupled to the converter circuit 22 and includes an output capacitor Co and an output load RL.

In the present embodiment, the high frequency time-division multi-phase power converter 2 is an isolated half-bridge DC converter. As shown in FIG. 12, the converter circuit 22 further includes a resonant tank 221 coupled to the first common point N21, including a resonant capacitor Cr, a resonant inductor Lr, and a magnetizing inductor Lm.

The converter circuit 22 further includes a coreless transformer 220 including a primary side coil L1 and a secondary side coil L2. The inductor L2m and the primary side coil L1 are connected in parallel with respect to the first common end N21 and the second common end N22. On the other hand, the converter circuit 22 further includes a rectifier circuit 222 coupled to the coreless transformer 220 and the output load circuit 25, including a plurality of rectifier components, and the rectifier components include diodes D1, D2, D3, and D4. It should be noted that the resonant tank 221, the coreless transformer 220, and the rectifier circuit 222 are similar to the corresponding circuits in the first embodiment, and the operation thereof is also the same as that described in the first embodiment, and thus will not be described herein.

Similar to the previous embodiment, the control circuit 26 can be configured to control the switching circuit 21 to be switched between multiple switching states. Here, ON states in a switching cycle of the first switches Q21, Q22, . . . , Q2N are mutually exclusive.

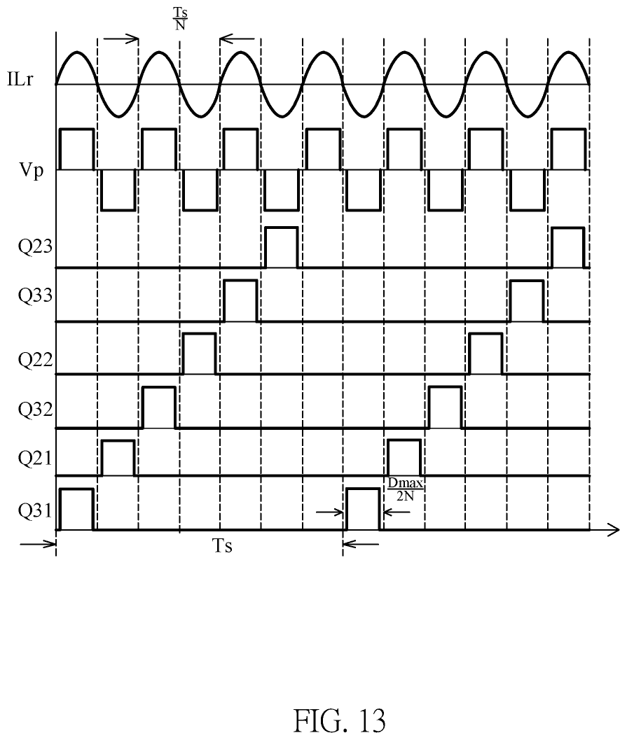

In detail, reference is now made to FIG. 13, which is a circuit operation timing diagram of a high frequency time-division multi-phase power converter according to the fifth embodiment of the present disclosure. When N is 3, the switches Q21, Q22, Q23, Q31, Q32, and Q33 may be power switches, and the respective ON states of the switches Q21, Q22, Q23, Q31, Q32, and Q33 in the switching cycle Ts are mutually exclusive. The voltage Vp of the magnetizing inductor Lm and the resonant inductor current ILr of the resonant inductor Lr are as shown in the drawings. The switching mechanism of the switches Q21, Q22, Q23, Q31, Q32, and Q33 is similar to that of the first embodiment, and therefore will not be described herein.

Similarly, since the operation period of the resonant inductor Lr is the switching period Ts divided by the number of switches Q21 to Q2N or Q31 to Q3N, that is, N, the frequency is also N times the switches Q21 to Q2N or Q31 to Q3N, thereby reducing the area of the resonant inductor Lr.

Similarly, the on-times of the switches Q21 to Q2N and Q31 to Q3N can be controlled by the control circuit 26 with pulse width modulation and can be obtained by dividing the maximum duty cycle Dmax with the numbers of switches Q21 to Q2N and Q31 to Q3N.

One of the beneficial effects of the present disclosure is that the provided high frequency time-division multi-phase power converter can be applied to reduce the area of passive components in various power converters by utilizing the switching circuit with multiple switches connected in parallel. Also, the high frequency time-division multi-phase power converter uses a coreless flat-panel transformer as the main transmission power structure for being thinner and lighter, the primary side switches are provided with zero voltage switching function, and the synchronous rectification technique is utilized on the secondary side, so as to reduce the switching loss and conduction loss of the circuit operating in high frequency.

Another advantageous effect of the present disclosure is that the high frequency time-division multi-phase power converter provided by the present disclosure replaces the existing silicon-based power switches with gallium nitride power components in the primary and secondary side switches, thereby reducing the power converter volume and high-frequency switching loss, improving the power density of the overall circuit, reducing coil loss by the improvement of coil order design, and improving transformer coupling coefficient to improve transmission efficiency.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

1. A high frequency time-division multi-phase power converter, comprising:
a power source;
a switching circuit coupled to the power source, including a first half bridge circuit and a second half bridge circuit connected in parallel, wherein the first half bridge circuit includes a first upper bridge switch and a first lower bridge switch, and the second half bridge switching circuit includes a second upper bridge switch and a second lower bridge switch;
a first resonant tank coupled to the switching circuit, including a first resonant inductor, a first resonant capacitor and having a first magnetizing inductance;
a coreless transformer coupled to the first resonant tank, including a primary side coil and a secondary side coil;
a second resonant tank coupled to the coreless transformer, including a second resonant capacitor and a second resonant inductor;
an output rectifier circuit coupled to the second resonant tank, including a plurality of rectifier components;
an output load circuit, including an output capacitor and an output load; and
a control circuit, configured to control the switching circuit to be switched between multiple switching states,
wherein ON states in a switching cycle of the first upper bridge switch, the first lower bridge switch, the second upper bridge switch, and the second lower bridge switch are mutually exclusive, and
wherein a first upper and lower bridge center point between the first upper bridge switch and the first lower bridge switch is connected to a second upper and lower bridge center point between the second upper bridge switch and the second lower bridge switch.

2. (canceled)

3. The high frequency time-division multi-phase power converter according to claim 1, wherein the first upper bridge switch, the first lower bridge switch, the second upper bridge switch, and the second lower bridge switch are gallium nitride switches.

4. The high frequency time-division multi-phase power converter according to claim 1, wherein the output rectifier circuit includes a first rectifier circuit and a second rectifier circuit connected in parallel, the first rectifier circuit includes a first rectifier component and a second rectifier component, the second rectifier circuit includes a third rectifier component and a fourth rectifier component, a first rectifier circuit center point between the first rectifier component and the second rectifier component is coupled to a first end of the second resonant tank, and a second rectifier circuit center point between the third rectifier component and the fourth rectifier component is coupled to a second end of the second resonant tank.

5. The high frequency time-division multi-phase power converter according to claim 4, wherein the first rectifier component, the second rectifier component, the third rectifier component, and the fourth rectifier component are rectifier diodes.

6. The high frequency time-division multi-phase power converter according to claim 5, wherein the rectifier diodes are Schottky diodes.

7. The high frequency time-division multi-phase power converter according to claim 4, wherein the first rectifier component, the second rectifier component, the third rectifier component, and the fourth rectifier component are gallium nitride switches.

8. The high frequency time-division multi-phase power converter according to claim 7, wherein the control circuit further controls the first rectifier component and the fourth rectifier component to be simultaneously turned on with the first upper bridge switch and the second upper bridge switch, and controls the second rectifier component and the third rectifier component to be simultaneously turned on with the first lower bridge switch and the second lower bridge switch.

9. The high frequency time-division multi-phase power converter according to claim 7, wherein
during ON states of the first upper bridge switch, the control circuit further controls the first rectifier component and the fourth rectifier component to be turned on after the first upper bridge switch is turned on, and controls the first rectifier component and the fourth rectifier component to be turned off before the first upper bridge switch is turned off,
during ON states of the first lower bridge switch, the control circuit further controls the first rectifier component and the fourth rectifier component to be turned on after the first lower bridge switch is turned on, and controls the first rectifier component and the fourth rectifier component to be turned off before the first lower bridge switch is turned off,
during ON states of the second upper bridge switch, the control circuit further controls the second rectifier component and the third rectifier component to be turned on after the second upper bridge switch is turned on, and controls the second rectifier component and the third rectifier component to be turned off before the second upper bridge switch is turned off, and
during ON states of the second lower bridge switch, the control circuit further controls the second rectifier component and the third rectifier component to be turned on after the second lower bridge switch is turned on, and controls the second rectifier component and the third rectifier component to be turned off before the second lower bridge switch is turned off.

10. The high frequency time-division multi-phase power converter according to claim 1, wherein ON-state times of the first upper bridge switch, the first lower bridge switch, the second upper bridge switch, and the second lower bridge switch in the switching cycle are respectively less than 25% of the switching cycle.

11. A high frequency time-division multi-phase power converter, comprising:
a power source;
a switching circuit coupled to the power source, including a plurality of first switches connected in parallel with respect to a first common end and a second common end;
a converter circuit coupled to the switch circuit, including a diode and an inductor;
an output load circuit, including an output capacitor and an output load; and
a control circuit, configured to control the switching circuit to be switched between multiple switching states,
wherein ON states in a switching cycle of the plurality of first switches are mutually exclusive,
wherein the converter circuit is coupled between the switching circuit and the output load circuit.

12. The high frequency time-division multi-phase power converter according to claim 11, wherein one end of the inductor is coupled to one end of the diode, the other end of the inductor is coupled to the output capacitor and the output load, the first common end of the switching circuit is coupled to the power source, and the second common end is coupled to a first node between the inductor and the diode.

13. The high frequency time-division multi-phase power converter according to claim 11, wherein one end of the inductor is coupled to the power source, the other end of the inductor is coupled to one end of the diode, the other end of the diode is coupled to the output capacitor and the output load, the first common end of the switching circuit is coupled to the power source, and coupled between the inductor and the diode, and the second common end is coupled to a ground end.

14. The high frequency time-division multi-phase power converter according to claim 11, wherein the converter circuit further includes:
a coreless transformer, including a primary side coil and a secondary side coil;
wherein one end of the inductor is coupled to the power source and one end of the primary side coil, the other end of the inductor is coupled to the other end of the primary side coil and the first common end of the switch circuit, and the second common end is coupled a ground terminal, and
wherein one end of the diode is coupled to the secondary side coil and the other end of the diode is coupled to the output capacitor and the output load.

15. The high frequency time-division multi-phase power converter according to claim 11, wherein the switching circuit further includes a plurality of second switches connected in parallel with respect to the first common end and a third common end, and the third common end is coupled to the power source, and the second common end is coupled to a ground end;
wherein the converter circuit further includes:
a resonant tank coupled to the first common end, including a resonant capacitor and the inductor as a resonant inductor and having a magnetizing inductance;
a coreless transformer coupled to the resonant tank, including a primary side coil and a secondary side coil; and
a rectifier circuit coupled to the coreless transformer and the output load circuit, including a plurality of rectifier components,
wherein one end of the diode is coupled to the secondary side coil, and the other end of the diode is coupled to the output capacitor and the output load.
